(19) United States
(12) Patent Application Publication
(10) Pub. No.: US 2019/0315540 A1
(43) Pub. Date: Oct. 17, 2019

(54) Packaging material made of lacquered aluminum

(71) Applicant: Constantia Teich GmbH, Weinburg (AT)

(72) Inventors: Werner Veit, Krems-Brunnkirchen (AT); Lambert Nekula, Hofstetten (AT); Martin Zwetzbacher, St. Pölten (AT)

(21) Appl. No.: 16/313,507

(22) PCT Filed: Jun. 21, 2017
(86) PCT No.: PCT/EP2017/065261

§ 371 Date: Dec. 27, 2018

(30) Foreign Application Priority Data
Jun. 27, 2016 (AT) A50577/2016
Oct. 28, 2016 (AT) A50994/2016

(51) Int. Cl. B65D 65/42; C09D 127/06; C09D 131/04; C09D 7/65; B65D 75/58

(52) U.S. Cl. CPC B65D 65/42; C09D 127/06; B65D 75/5844; C09D 7/65; C09D 131/04

(57) ABSTRACT

A packaging material made of a support layer of aluminum and a lacquer layer applied onto the support layer with excellent opening behavior. The lacquer of the lacquer layer consists of a solvent, a binder, and a plasticizer. A polymer binder with a molecular weight of at least 80,000 Dalton, preferably at least 100,000 Dalton, is used, and by virtue of the mixing ratio between the solvent, the binder, and the plasticizer, a bond strength between the lacquer layer and the support layer ranging from 0.07 N/50 mm to 0.30 N/50 mm and an elongation at break of the lacquer layer of at least 150% are set.

### TECHNICAL FIELD

The present teaching relates to a packaging material consisting of an aluminum support layer and a lacquer layer applied thereto at least in part.

### BACKGROUND

In the food industry, wraparound packaging based on printed aluminum foils are often used, in particular when packaging seasonal products such as chocolate Easter eggs, chocolate Easter bunnies, etc. In this case, the printed side is on the outside, and the outer side can also be coated (e.g. with a polypropylene film) in order to protect the printed image. Every consumer of such products in wraparound packaging are aware of the problem that packaging of this kind, or a desired or provided part thereof, can at times be separated from the contents only with difficulty. When unwrapping the contents, experience has shown that the wraparound packaging often tears into small parts and cannot be removed in one piece. In the case of chocolate bars that are wrapped in aluminum foil, the intention is often to only partially unwrap the chocolate bar. A similar problem occurs here, whereby the aluminum foil to be removed cannot be removed, or can be done so only with difficulty, and in particular not in one piece, because said foil in turn tears into smaller parts. This is naturally annoying and frustrating for the consumer. For cost reasons, the wraparound packaging is naturally intended to be as thin as possible. Thicker wraparound packaging is therefore generally not a solution to this problem.

### SUMMARY

It is therefore an object of the present teaching to provide a packaging material which can in particular also be used as wraparound packing and which ensures excellent opening behavior of packaging produced using said material by uncontrolled tearing of the packaging material during manual opening being prevented to the greatest extent possible.

This object is achieved by the lacquer of the lacquer layer consisting of a solvent, a binder and a plasticizer, a polymeric binder having a molecular weight of at least 80,000 Daltons, preferably at least 100,000 Daltons, being used, and a bond strength between the lacquer layer and the support layer in the range of 0.07 N/50 mm and 0.30 N/50 mm and an elongation at break of the lacquer layer of at least 150% being set by the mixing ratio of the solvent, binder and plasticizer. The bond strength being set lower than usual ensures that the thin lacquer layer does not tear together with the aluminum, but rather separates from the aluminum of the support layer and is then used to reinforce the aluminum layer. The lacquer layer has a sufficiently high elongation at break for this purpose, as a result of which the lacquer layer can be stretched to a significant degree before it tears. In this way, the packaging material according to the present teaching exhibits outstanding opening behavior, as a result of which the packaging material can be prevented from tearing during opening in the region of the lacquer layer.

In particular on account of partial application of the lacquer layer, packaging using packaging material of this kind thus also allows advantageous functions to be realized which facilitate handling of the packaging, in particular the opening thereof. For example, omitting the lacquer layer in regions makes it possible for an opening aid to be formed along which the packaging can be opened in a secure and targeted manner. Equally, the partial application makes it possible for a tear strip to be formed along which a packaging item can be opened in a secure and targeted manner.

The lacquer preferably contains 10 to 50 wt. % binder, 1 to 30 wt. % plasticizer and 20 to 80 wt. % solvent. The bond strength and the elongation at break can be set very advantageously in these ranges.

When an additive is also contained in the lacquer, specific properties of the packaging material can be influenced in a targeted manner. In particular, the additive can influence, i.e. enhance, the bond strength (in this case the additive is an adhesion promoter), or also decrease it. The lacquer preferably contains 0 to 5 wt. % additive for this purpose.

### BRIEF DESCRIPTION OF THE DRAWINGS

The present teaching is explained in more detail in the following with reference to FIGS. 1 to 4, in which, by way of example, schematically, and in a non-limiting manner,

FIG. 1 shows the structure of a packaging material according to the present teaching,

FIG. 2 shows a packaging item for a seasonal product using a packaging material according to the present teaching,

FIG. 3 shows a packaging item using a packaging material according to the present teaching with an opening aid, and

FIG. 4 shows a packaging item using a packaging material according to the present teaching with a tear strip.

### DETAILED DESCRIPTION

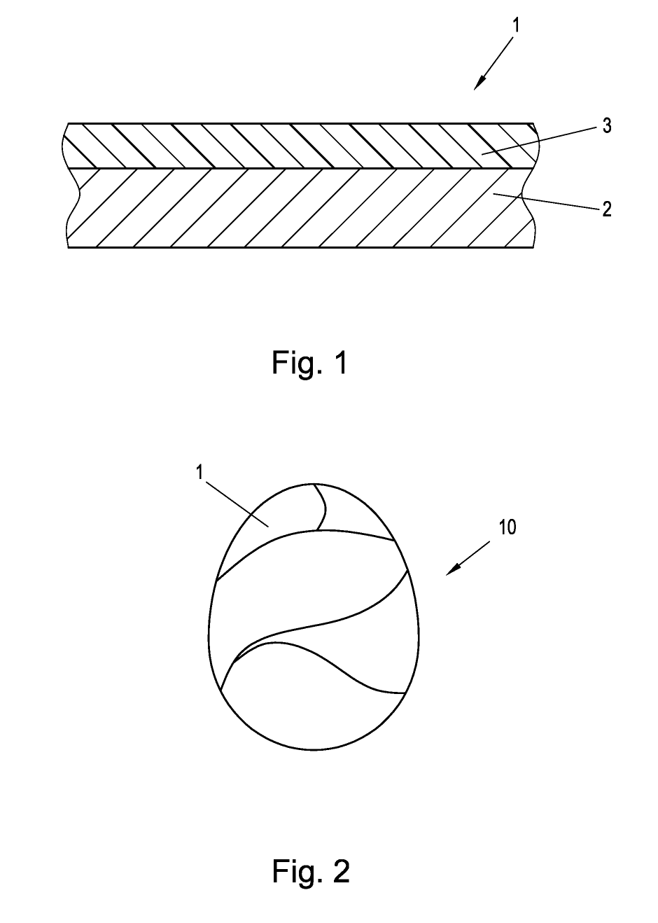

The packaging material 1 according to the present teaching for wraparound packaging, as shown in FIG. 1, has an aluminum support layer 2. The thickness of the aluminum support layer 2 is in the range of from 5-20 μm, preferably 5-10 μm, for the present application. A lacquer layer 3 having a thickness in the range of from 5-15 μm is applied to at least one side of the support layer 2.

A mixture of a binder, a plasticizer and a solvent is used as the lacquer for the lacquer layer 3. According to the present teaching, the lacquer contains 10 to 50 wt. % (weight percent) binder, 1 to 30 wt. % plasticizer and 20 to 80 wt. % solvent. In addition, additives, for example adhesion promoters, may also be present in small amounts, 0 to 5 wt. %.

The lacquer layer 3 has to exhibit particular properties in order to result in a packaging material 1 together with the aluminum support layer 2 that meets the requirements.

Experiments by the applicant have demonstrated that in particular two properties are key for this purpose.

The first is the bond strength between the aluminum support layer 2 and the lacquer layer 3. It is clear that there has to be a minimum bond strength as otherwise there would be undesirable delamination, resulting in the two layers being separated. It has nevertheless been found that, surprisingly, the bond strength does not actually have to be too great. If the packaging material 1 is pulled, as is the case when opening packaging made from packaging material 1 of this kind, the aluminum of the support layer 2 tears at some point. If the bond strength between the aluminum support layer 2 and the lacquer layer 3 is too great, the lacquer layer 3 would tear therewith because the lacquer of the lacquer layer 3 is applied very thinly, as a result of which there would be opening behavior which is substantially unchanged with respect to the known packaging materials. The experiments by the applicant have demonstrated that the bond strength between the aluminum support layer 2 and the lacquer layer 3 has to be in the range of from 0.07 N/50 mm and 0.30 N/50 mm. This makes it possible to ensure that the lacquer layer 3 does not tear together with the aluminum of the support layer 2.

The bond strength alone is however insufficient to achieve the desired properties of the packaging material 1. The lacquer layer 3 also has to be sufficiently tough in order to prevent the lacquer layer 3 tearing despite the low layer thicknesses. This makes it possible for the aluminum of the support layer 2 to tear but with the lacquer layer 3 remaining intact and not tearing therewith in the process. The lacquer layer 3 is therefore used as type of reinforcing lacquer for the aluminum support layer 2.

Only bond strength in the specified range in combination with the toughness ensures that the opening behavior of the packaging material 1 has the desired properties.

The bond strength is measured by means of a bond strength test/separation test of the layers according to the DIN 53357 standard. The test is carried out e.g. on a tensile strength measurement instrument from the Zwick company. In the test, the support layer 2 and the lacquer layer 3 of the packaging material 1 are partially separated, are clamped separately from one another in the tensile strength measurement apparatus and are then pulled apart, and the force required to pull them apart is measured. The parameters for the separation test are a specimen width of 50 mm (hence the unit N/50 mm), a pulling speed of 100 mm/min, a clamping length of the support layer 2 and the lacquer layer 3 of a maximum of 50 mm and a pulling angle of 90°. The tensile strength measurement apparatus determines the extreme values as well as the average values of the force in N/50 mm required for the pulling apart, with the extreme value being indicated in this case.

The bond strength is set in particular by the lacquer formulation, with in particular the binder, and an adhesion promoter which may be present as an additive, influencing the bond strength to the aluminum support layer 2.

In order to achieve the high toughness, according to the present teaching a high-molecular polymeric binder having high internal cohesion is used for the lacquer of the lacquer layer 3. The molecular weight M of the binder is used as a measure of the internal cohesion of the binder. The higher the internal cohesion, the tougher and more stretchable the lacquer is, and the later the lacquer tears. It has been established in this connection that the molecular weight of the binder has to be at least 80,000 Daltons, preferably at least 100,000 Daltons in order to achieve the desired material properties of the packaging material 1. The molecular weight is usually a specification by the manufacturer of the binder.

The molecular weight is measured for example using the known method of gel permeation chromatography and a suitable molar mass standard or using mass spectrometry. The industry-wide polystyrene standard is used as the molar mass standard. By using gel permeation chromatography, the binder, dissolved for example with tetrahydrofuran, is introduced into the separation column of the gel permeation chromatography measurement apparatus and the refractive index is measured using a refractive index detector (RI detector). The refractive index makes it possible to ascertain the molecular weight M.

The elongation at break of the lacquer layer 3 is used as a measure of the toughness of the lacquer layer 3. For this purpose, a lacquer film is produced having a thickness which is as even as possible, and only this lacquer film is subjected to a tensile test according to the ISO 527-1 standard. In this test, the elongation at break of the lacquer layer is measured in %, and optionally the tensile strength thereof is also measured in N/mm². The tensile test is carried out as follows: The prepared specimen of the lacquer layer (100×15 mm) is loaded with a tensile strength on the tensile machine until it breaks. In this process, the specimen is clamped in the tensile measurement apparatus such that the longitudinal axis of the specimen coincides with the effective line of the tensile force. The zero point position of the tensile force and of the distance is to be checked and ensured before the start of the tensile test. The required stretch speed is set at 100 mm/min. The stretching of the specimen is determined with reference to the distance measurement range of the tensile measurement apparatus. For the use in a packaging material 1 according to the present teaching, the lacquer or a lacquer film produced therefrom should have an elongation at break of at least 150% in the desired thickness range of from 4 to 15 μm, which corresponds to approximately 4 to 14 g/m² (gram dry weight). The elongation at break of a specific lacquer formulation thus also influences the possible thickness of the lacquer layer 3.

For the packaging material 1 according to the present teaching, high-molecular polymeric binders are considered which are based on thermoplastic materials, such as a styrene-butadiene-styrene (SBS), styrene-butadiene copolymer (or also block copolymer) (SBC), polyvinyl acetate (PVA), polyvinyl chloride (PVC) or a polyvinyl alcohol (PVOH), based on epoxides, based on polyester resins or based on acrylates. The use of different combinations of binders (also as copolymers) in the lacquer is also conceivable.

According to the present teaching, a monomeric plasticizer, such as dioctyl adipate (DOA), dibutyl sebacate (DBS), acetyltributylcitrate (ATBC), epoxidized soybean oil (ESO), etc., or a polymeric plasticizer, such as polyesters, polyurethanes, castor oil, acrylates, alkyd resins, etc., is used as, a preferably low-molecular (molecular weight<1,000 Daltons), plasticizer. The ratio of the plasticizer to the binder also influences the toughness of the lacquer layer 3. Too much plasticizer leads to the lacquer being too soft and the lacquer layer therefore lacking strength. Different plasticizers can also be used in the lacquer.

According to the present teaching, methyl ethyl ketone (MEK), acetone, ethyl acetate, ethanol or even water can be used as a solvent. The solvent naturally has to be compatible with the binder and the plasticizer, as well as with the optional additives. In addition, the selection of the solvent also depends on the desired application method, the drying characteristics and the dry layer thickness of the lacquer layer 3.

An additional adhesion promoter can also be used as the most prominent additive in order to reinforce the adhesive properties of the binder with respect to aluminum. A polyurethane-based adhesive can be used as a possible adhesion promoter. An additive can also be used to reduce adhesion that is too high, however. Other typical additives are hydroxy- or carboxy-functionalized acrylates, polyurethanes, polyvinyl chlorides, polyesters, epoxides, as well as silanes, titanates, zirconates, polyethylenimines, phosphoric acid esters, sucrose derivatives, chlorinated polyolefins, silicones (all as adhesion promoters or adhesion reducers) or fillers, such as talc or silicic acid, or matting agents. Naturally, a plurality of different, and also additional, additives can also be used.

In order to obtain a suitable lacquer for the lacquer layer 3, for example the following process is followed. First, the binder is selected according to the application. A solvent that is compatible with the selected binder is then selected, which solvent also allows the selected method of application of the lacquer onto the support layer 2. A compatible plasticizer is also selected. For an application in the food industry, all components of the lacquer of course have to be harmless in terms of provisions for coming into contact with food, e.g. EU Directive 1935/2004/EC for Europe. The toughness (elongation at break of a lacquer film) of the lacquer is set by the proportions of binder, plasticizer and solvent, and can be controlled by tensile tests. The bond strength of the lacquer to aluminum is also set by the proportions of binder, plasticizer and solvent and tested using a separation test. The bond strength can be influenced by adding an additive. Setting the proportions of binder, plasticizer and solvent can also be repeated in a plurality of iterations in order to obtain the desired properties of the packaging material 1.

Two possible lacquer formulations are presented in the following as embodiments. In so doing, substances are specified in terms of their general substance names without a specific supply source, whereas commercially available products are specified with a type designation and a supply source.

Lacquer 1:

Solvent 74.42 wt. % MEK

Binder 14.88 wt. % Vinnol H11/59 from Wacker Chemie AG. This is a copolymer of vinyl chloride and vinyl acetate. The molecular weight M measured using the gel permeation chromatography and a polystyrene standard is between 80,000 and 120,000.

Plasticizer 5.58 wt. % Dynapol LS 615 (a polyester resin) from Evonik Industries AG and 2.33 wt. % Rokralux VP 5797 (an alkyd resin) from Robert Kraemer GmbH & Co. KG.

Additive 2.79 wt. % Adcote 811 A (a polyurethane-based adhesive) from the Rohm & Haas company as an adhesion promoter.

Lacquer 2:

Solvent 76.56 wt. % MEK

Binder 15.31 wt. % Vinnol H11/59 (copolymer of vinyl chloride and vinyl acetate) from Wacker Chemie AG.

Plasticizer 5.74 wt. % Dynapol LS 615 (a polyester resin) from Evonik Industries AG and 2.39 wt. % Rokralux VP 5797 (an alkyd resin) from Robert Kraemer GmbH & Co. KG.

The bond strength test resulted in a bond strength value of 0.26 N/50 mm for lacquer 1, and 0.08 N/50 mm for lacquer 2.

The effect of the lacquer as a lacquer layer 3 on an aluminum support layer 2 is documented by a tensile test according to the ISO 527-1 standard, the tensile strength being measured in N/mm² and the elongation at break being measured in %. For the tensile test, a support layer 2 having a layer thickness of 6.7 μm and a lacquer layer 3 having a grammage of 12.5 g/m2 (resulting in a layer thickness of approximately 13.9 μm in the case of a density of the lacquer of approximately 900 kg/m³) is used. The test is carried out as described above, wherein a packaging material 1 (100×15 mm) being used as the specimen.

By way of comparison, the tensile test is also carried out on the aluminum support layer 2 without a lacquer layer 3, and on a support layer 3 having a heat-sealing lacquer (HSL), for example a heating-sealing lacquer having product number 58357000020 from the Constantia Teich company. The results are summarized in the following table.

| | | Support | Support | Support |
|---|---|---|---|---|
| | Only support | layer + | layer + | layer + |
| | layer | HSL | lacquer 1 | lacquer 2 |
| Tensile strength | 86.51 | 107.37 | 98.35 | 102.18 |
| [N/mm²] | | | | |
| Elongation at | 2.2 | 6.9 | 176.3 | 188.4 |
| break of packaging | | | | |
| material [%] | | | | |
| Elongation at | | Not | 178.2 | 207.5 |
| break [%] of | | measurable | | |
| lacquer layer alone | | | | |
| (at thickness of | | | | |
| 12.5 g/m²) | | | | |
| bond strength | | Not | 0.13 | 0.26 |
| [N/50 mm] | | measurable | | |

The effect is immediately clear from the above table. Conventional materials have a very low elongation at break, which leads to the material tearing very quickly when pulled, even if the tensile strength of the packaging material is in a similar range to a packaging material 1 according to the present teaching (e.g. in the case of support layer+HSL). By contrast, a packaging material 1 according to the present teaching has a considerably higher elongation at break, which can also be exploited on account of the low bond strength. The support layer 2 tearing thus does not immediately lead to the packaging material 1 tearing, but the lacquer layer 3 rather reinforces the packaging material 1 in terms of the opening properties. This effect was also confirmed in a test for use as wraparound packaging for a seasonal product. The seasonal product could be opened easily using the packaging material 1 according to the present teaching.

The elongation at break for a heat-sealing lacquer cannot be measured since no film, and therefore no specimen, can be produced therewith for a tensile test.

In a conventional packaging material comprising an aluminum support layer and a heat-sealing lacquer (HSL) lacquer layer, the bond strength between the aluminum and the lacquer is so high that the lacquer layer simply cannot be separated from the aluminum, at least not in a non-destructive manner.

In a conventional, laminated packaging material, however, for example of the paper/aluminum or plastics/aluminum type, in which a material layer is laminated onto an aluminum, the targeted bond strengths are typically at least 0.7 N/50 mm and go as far as 30 N/50 mm, and are thus significantly beyond the range according to the present teaching.

The tensile strength of the packaging material 1 is of course so high that the packaging material 1 can be pulled during use as wraparound packaging without immediately tearing.

The lacquer layer 3 is preferably applied to the support layer 2 in liquid form in the rotation method, for example a roller coating method, or in the slotted-nozzle coating method. The solvent of the lacquer is evaporated, as a result of which the lacquer forms a film as a lacquer layer 3 on the support layer 2. The evaporation can be supported by corresponding heating or radiation (e.g. UV or IR radiation).

Alternatively, the lacquer layer 3 can also be applied to the support layer 2 in an extrusion method.

Printing may also take place on the surface of the support layer 2 facing the lacquer layer 3 before the application of the lacquer layer 3. The print can then also be protected by the lacquer layer 3 at the same time. For this purpose, the support layer 2 may also be lacquered with a print undercoat before the printing. In the case of a lacquer having water as the solvent, the print undercoat can either be water-based or non-water-based. Water does not generally have sufficient solubilizing power in order to partly dissolve the dried print undercoat, which would lead to a bond between the print undercoat and the lacquer of the lacquer layer in the liquid phase, and thus to a strong bond. In the case of a lacquer having a solvent that is not water, the print undercoat nevertheless has to be water-based because the solvent-based lacquer of the lacquer layer 3 does not bond sufficiently with the water-based print undercoat layer and thus do not change the adhesive properties. It would be different in the case of a solvent-based print undercoat since the solvent-based lacquer of the lacquer layer 3 would partly dissolve the print undercoat, resulting in a bond in the liquid phases, which would change the adhesive properties in the packaging material 1. Under the above conditions, the aluminum support layer 2 having a print undercoat and the printing behaves, with respect to the lacquer layer 3 according to the present teaching, substantially in the same way as a blank aluminum surface. A packaging material 1 of this kind would also exhibit the desired behavior.

The packaging material 1 according to the present teaching is used for example as wraparound packaging 10 for seasonal products, such as a chocolate Easter egg as shown in FIG. 2, wherein the lacquer layer 3 being arranged so as to face away from the packaged good. In applications of this kind, the lacquer layer 3 is advantageously applied on the entire surface of the support layer 2.

Of course, it is also possible for the lacquer layer 3 according to the present teaching to be applied on the support layer 2 only in part. This makes it possible for different functions to be realized in a packaging item 10 with the packaging material 1.

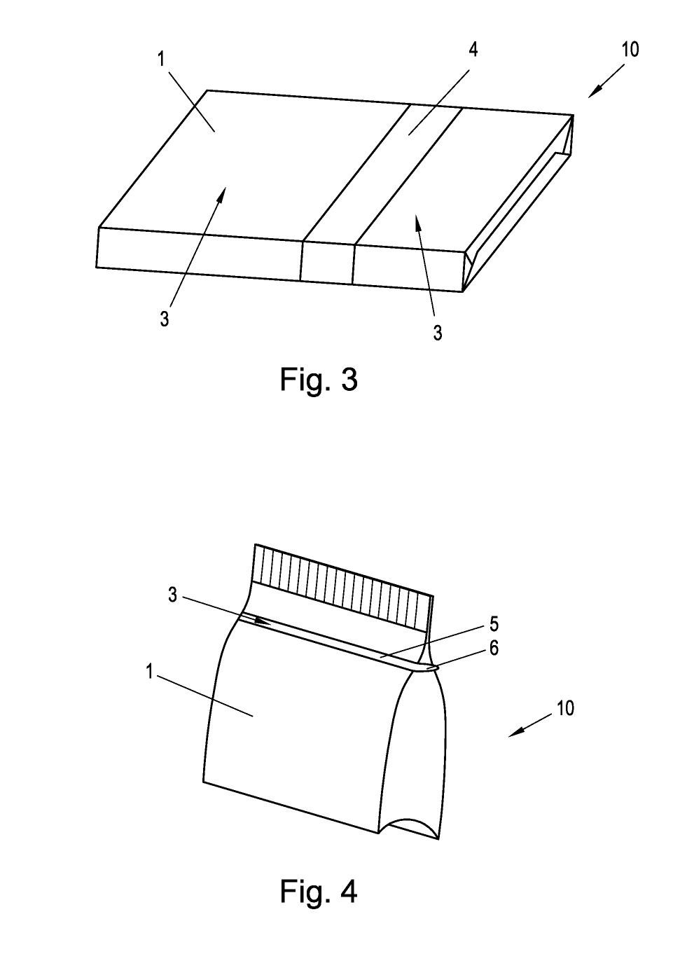

For example, the lacquer layer 3 could be omitted at certain regions of the packaging material 1. This results in the packaging material 1 tearing more easily at said omission regions than at regions having the lacquer layer 3. The omission regions can in this case be arranged on a packaging item 10 made from a packaging material 1 such that an opening aid 4 is formed thereby, as shown in FIG. 3 with the example of packaging for a chocolate bar. If the consumer pulls the part of the packaging material 1 having the lacquer layer, the packaging 10 designed in this way will tear at the regions without the lacquer layer 3, i.e. in the region of the opening aid 4. The lacquer layer 3 at the other regions ensures that the packaging material 1 can be cleanly separated from the packaged good, and in particular does not tear in these regions.

In this case it does not matter whether the lacquer layer 3 is applied on the entire surface and subsequently removed, for example by means of a laser, at the desired positions, or whether the lacquer layer 3 is applied to the support layer 2 only at the intended positions. In order to facilitate or improve the laser treatment, a laser-sensitive or laser-absorptive substance may also be contained in the lacquer or lacquer layer 2 as an additive. Such substances and the use thereof are well known per se.

The properties of the lacquer layer 3 can however also be used to form a tear strip 5 in a targeted manner, as shown by way of example in FIG. 4. For this purpose, too, the lacquer layer 3 is applied to the support layer 2 only in part, in particular in the regions forming the tear strip 5. The lacquer layer 3 ensures that when the tear strip 5 is pulled by the consumer, preferably at a tab 6 that is formed, said tear strip is cleanly separated from the rest of the packaging material 1, and a packaging item 10, such as a bag as in FIG. 4, can be cleanly opened along the tear strip 5.

It goes without saying that both an opening aid 4 and a tear strip 5 may be provided at any desired position intended therefor on a packaging item 10 and may be provided in any desired geometric shape.

1. A packaging material consisting of an aluminum support layer having a layer thickness in the range of 5-20 μm and a lacquer layer applied thereto at least in part and having a layer thickness in the range of 4-15 μm, wherein the lacquer of the lacquer layer consists of a solvent, a binder and a plasticizer, wherein a polymeric binder having a molecular weight of at least 80,000 Daltons is used, and a bond strength between the lacquer layer and the support layer in the range of 0.07 N/50 mm and 0.30 N/50 mm and an elongation at break of the lacquer layer of at least 150% is set by the mixing ratio of the solvent, binder and plasticizer.

2. The packaging material according to claim 1, wherein 10 to 50 wt. % binder, 1 to 30 wt. % plasticizer and 20 to 80 wt. % solvent are contained in the lacquer.

3. The packaging material according to claim 1 wherein an additive, preferably an adhesion promoter for improving the adhesion to aluminum, is contained in the lacquer.

4. The packaging material according to claim 3, wherein 0 to 5 wt. % additive is contained in the lacquer.

5. The packaging material according to claim 1, wherein the lacquer layer is applied on the entire surface of the support layer.

6. A packaging made of a packaging material according to claim 1, wherein an opening aid is formed on the packaging by regions not having the lacquer layer.

7. A packaging made of a packaging material according to claim 1, wherein a tear strip is formed on the packaging by regions having the lacquer layer.

8. The packaging material according to claim 1, wherein the aluminum support layer has a layer thickness in the range of 5-10 μm.

9. The packaging material according to claim 1, wherein the polymeric binder has a molecular weight of at least 100,000 Daltons.
